(19) United States
(12) Patent Application Publication
(10) Pub. No.: US 2006/0143571 A1
(43) Pub. Date: Jun. 29, 2006

(54) Multiple mouse cursors for use within a viewable area for a computer

(76) Inventor: Wilson Chan, San Jose, CA (US)

Correspondence Address: ADOBE SYSTEMS, INCORPORATED;c/o PARK, VAUGHAN & FLEMING LLP, 2820 FIFTH STREET, DAVIS, CA, 95616-2914, US

(21) Appl. No.: 11/025,492

(22) Filed: Dec. 29, 2004

(51) Int. Cl. G06F 9/00

(52) U.S. Cl. 715/764; 715/856; 715/862

(57) ABSTRACT

Methods are disclosed for displaying and manipulating a plurality of mouse cursors at different locations in a viewable area for a computer. As preferred, only one mouse cursor is active and moveable at any one time, with the user being allowed to switch or toggle among them to activate an appropriate mouse cursor. Each mouse cursor is preferably restrained within a region of the viewable area of the monitor or monitors with which the technique is employed. The user can select among the active and inactive mouse cursors for example by pressing an appropriate key on the keyboard. The regions associated with the mouse cursors can be defined to suit user preferences, and can be set up to encompass logical regions within the viewable area. Alternatively, each cursor is not restrained to its particular region, and more than one mouse cursor can appear within the same region. Data associated with the presently-active cursor can be automatically moved to a newly-active cursor when the cursors are switched.

### FIELD OF THE INVENTION

The present disclosure relates to a method and apparatus for using multiple mouse cursors within the viewable area for a computer.

### BACKGROUND OF THE INVENTION

As computer technology matures, the amount of information a user might wish to display on the screen of his computer is increasing. As a result, users strive to increase the amount of viewable area for the graphical user interfaces for their computers, such as by using two monitors (FIG. 1) or using monitors of larger size (FIG. 2).

FIG. 1 illustrates a dual-monitor set up, in which a computer 10 is used to run two monitors 12a, 12b simultaneously. Using such a set up, the amount of viewable area is effectively doubled. When using dual monitors, the computer 10 is usually configured (e.g., in software or hardware) so that the viewing area of both monitors essentially constitutes a single monitor, albeit not a perfectly contiguous one. Thus, for example, a user can use his mouse 16, keyboard 14, touch pad, or other input device to move a mouse cursor or mouse pointer 30 between the two monitors 12a, 12b. As one skilled in the art will understand, when so configured, when the mouse cursor 30 is moved beyond the left edge of right monitor 12b, it will then appear at the right edge of the left monitor 12a, and vice versa. In this way, a user can display different portions of a particular application program 20 on both monitors 12a, 12b (as shown), or can display different application programs on the two monitors, with the ability to move the mouse cursor 30 between the two monitors with relative ease. Of course, more than two monitors 12a, 12b can be used in similar fashion, and the illustration of a dual monitor set up is merely exemplary.

As shown in FIG. 1, the user is shown using an illustration application program 20, such as Adobe Photoshop™, Adobe Illustrator™, Adobe InDesign™ or like program. The user has displayed the main workspace for his document on the left monitor 12a where he is engaged in drawing a number of shapes 22, and has moved various palettes 24 to the right monitor 12b. As one skilled in the art will understand, the palettes 24 provide the user various selections to be applied to the shapes 22, and one such palette is shown to allow the user to select various fills for the shapes 22. By moving the palettes 24 to the right monitor 12b, the viewing area of the main workspace is not obscured, which is generally preferred by the user and increases the utility of the palettes.

However, with the viewable area increased in this fashion, the user now may have to move the mouse cursor 30 through relatively long distances. For example, if the user wishes to provide a fill to shape 22a, he must first select the shape 22a using the mouse cursor 30, then move the mouse cursor over to the right monitor 12b to select the appropriate fill from the palette 24, and then move the mouse cursor 30 back to the shape 22a to apply the selected fill, as exemplified by the dotted-line arrow in FIG. 1. Of course, some of these selections are not always necessary in a filling application, but the point is that the user will often have to move the mouse cursor from left to right and then back again. Moving this long distance is generally inconvenient to the user, who might, for example, have to repeatedly move the mouse 16 to eventually coax in step-wise strokes the mouse cursor to the correct position within the viewable area of the monitors 12a, 12b. Additionally, in moving the mouse cursor 30 through such long distances, the user may tend to forget the context of the task he was performing.

The foregoing is merely one example of the problems caused by increases in viewable area and its concomitant requirement to move the mouse cursor 30 through long distances. Other applications will suffer from the same problem, such as moving, copying, or pasting files or objects from one portion of the viewable area to another, or among application programs 20, etc. Moreover, the problem is not limited to the use of multiple-monitor set ups. Thus, FIG. 2 shows a single-monitor set up, in which the shapes 22 and palettes 24 of the exemplary illustration program 20 are conventionally displayed in different locations within the viewing area of the single monitor 12. In this circumstance, the mouse cursor 30 must still be made to move over relatively long distances. In another example, as the viewable area increases, it may become more tedious to move the mouse cursor 30 between the main workspace and the menu/toolbar area 32 of the graphical user interface, from which the user can select various functions and options relevant to manipulating the objects in the workspace.

The salient point is that as viewable areas for computers increase, the problem of having to move the mouse cursor 30 over relatively long distances also increases. This tends to make user interaction with the graphical user interface less efficient and tiring. The subject matter of the present disclosure is directed to addressing these and other problems.

### SUMMARY OF THE DISCLOSURE

Methods are disclosed for displaying and manipulating a plurality of mouse cursors at different locations in a viewable area for a computer. In a preferred embodiment, only one mouse cursor is active and moveable at any one time, with the user being allowed to switch or toggle among them to activate an appropriate mouse cursor. Each mouse cursor is preferably, but not necessarily, restrained within a region of the viewable area of the monitor or monitors with which the technique is employed. The user can select among the active and inactive mouse cursors in different ways, such as by pressing an appropriate key on the keyboard, by moving the active cursor to the border of its region, etc. Inactive mouse cursors are preferably centered in their respective regions when rendered inactive, although they can also be left in last active positions. The regions associated with the mouse cursors can be defined to suit user preferences, and can be set up to encompass logical regions within the viewable area (e.g., left and right portions, quadrants, main workspace, menu/toolbar areas, etc.). Particular regions can span past the physical borders of the monitors, and can also be made to overlap. In an alternative embodiment, each cursor is not restrained to its particular region, and more than one mouse cursor can appear within the same region. Data associated with the presently-active cursor can be automatically moved to a newly-active cursor when the cursors are switched. Using the disclosed technique, the distance that the cursors must move is lessened, making it simpler for the user to interact with the graphical user interface present within the viewable area.

The foregoing summary is not intended to summarize each potential embodiment or every aspect of the present disclosure.

### BRIEF DESCRIPTION OF THE DRAWINGS

The foregoing summary, preferred embodiments, and other aspects of subject matter of the present disclosure will be best understood with reference to a detailed description of specific embodiments, which follows, when read in conjunction with the accompanying drawings, in which:

FIG. 1 illustrates a dual-monitor set up and illustrates the movement of a mouse cursor in accordance with the prior art.

FIG. 2 illustrates a single-monitor set up and illustrates the movement of a mouse cursor in accordance with the prior art.

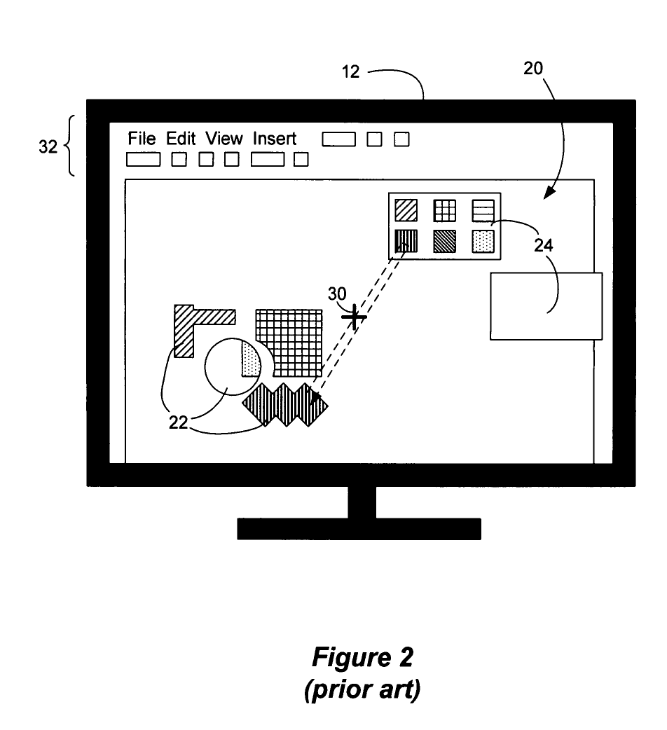

FIG. 3 illustrates a dual-monitor set up in accordance with an embodiment of the invention, in which two mouse cursors are present, each confined within a region.

FIGS. 4A-4C illustrate use of the mouse cursors of FIG. 3 to fill an shape by switching or toggling between the two cursors.

FIGS. 5A-5B illustrate use of the mouse cursors of FIG. 3, in which one cursor is rendered inactive and is centered when it is moved to the edge of its region.

FIGS. 6A-6C illustrate the use of embodiment of the invention in a single-monitor set up, in which regions binding the mouse cursors are positioned at different locations on the monitor.

FIG. 7 illustrates a dual-monitor set up, in which multiple mouse cursor regions are shown, one of which spans between the two monitors.

FIG. 8 illustrates an embodiment of the invention, in which two mouse cursors are present within a single region.

FIGS. 9A-9B illustrate an embodiment of the invention, which illustrates the association of the mouse cursors with data and the ability to switch such associated data between the active and inactive cursors.

While the disclosed techniques are susceptible to various modifications and alternative forms, specific embodiments are shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. § 112.

### DETAILED DESCRIPTION

To solve the foregoing problems of the prior art, the user's viewable area displays a plurality of mouse cursors at different locations. In a preferred embodiment, only one mouse cursor is active at any one time, with the user being allowed to select among them to activate an appropriate mouse cursor. For example, and as a quick summary of one aspect of the technique, in a dual-monitor set up, one mouse cursor can be located in the right monitor, while the other mouse cursor can be located in the left monitor. Furthering the example set forth in the Background section, the user selects (i.e., activates) the left monitor 12a's mouse cursor to select an appropriate shape 22 for filing; then selects (activates) the right monitor 12b's mouse cursor; moves the right monitor 12b's mouse cursor to select an appropriate fill from a palette 24 on the right monitor; re-selects the left monitor 12's mouse cursor; and then moves the left monitor 12a's mouse cursor back to the shape to apply the fill. Using this scheme, the amount that the user must move the mouse cursor is lessened.

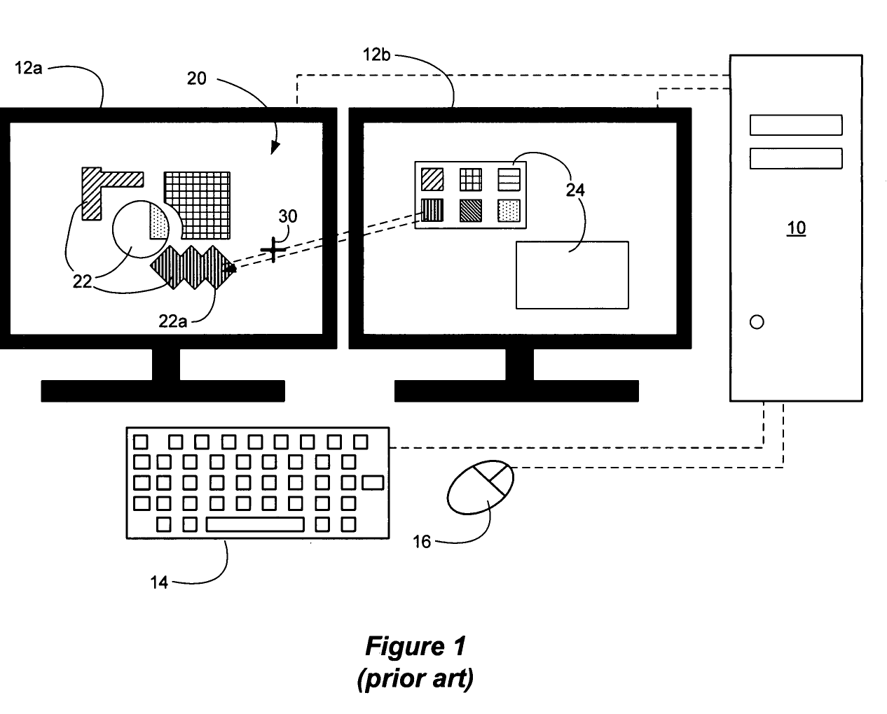

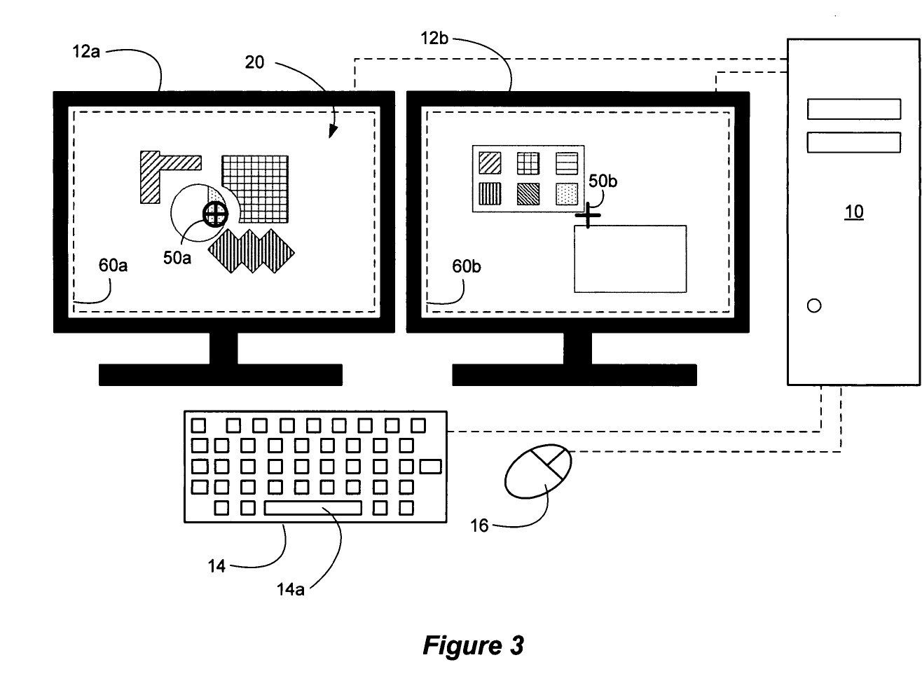

Further details and other aspects of the technique are first illustrated with reference to FIG. 3, which like FIG. 1 illustrates a dual-monitor set up. In FIG. 3 and other figures that follow, aspects of the graphical user interface not related to the mouse cursor (the shapes, palettes, menus, toolbars, etc.) are lightened or greyed to allow aspects relevant to the mouse cursor to be emphasized. As shown, two mouse cursors are shown, 50a, 50b. In this embodiment, each mouse cursor is constrained in its movement by regions 60a, 60b. As shown, region 60a corresponds to the viewable area encompassed by the left monitor 12a, while region 60b corresponds to the viewable area encompassed by the right monitor 12a. (As shown, the regions 60a, 60b are shown as slightly smaller than the viewing area of the two monitors, but this is merely for clarity, and one skilled in the art will understand that the regions would logically encompass the entirety of the viewing area for each monitor).

As a default, the mouse cursors 50a, 50b are initially set for display in the centers of their respective regions 60a, 60b as shown, although other default locations or pre-determined locations could be used as well (e.g., the upper left corners of the regions). As noted earlier, only one mouse cursor 50a or 50b is active at any given time, meaning that only one is capable of being moved with the mouse 16 or other input device. As illustrated, the active cursor is 50a, which is shown as a circled cursor. The other mouse cursor, 50b, is currently inactive, meaning that it is not presently capable of being moved using the mouse 16 or other input device. Inactive mouse cursor 50b is not circled to represent the same, and to differentiate it from the active mouse cursor 50a. Of course, in a commercial embodiment, highlighting of the active cursor could be achieved in ways other than changing that's cursor's shape, such as by graying the inactive cursor or rendering it transparent, by providing different colors for the active and inactive cursors, by causing the active cursor to blink, etc. In other words, the active and inactive cursors are preferably made visually-perceptibly different. In any event, the active mouse cursor 50a is controllable in its movement within region 60a, preferably by the mouse 16, although other input devices can be used to move the active cursor 50a such as the keyboard 14 or other input devices as known in the art. So activated, mouse cursor 50a can be used to perform, within region 60a, any of the functions normally performed by mouse cursors, such as selecting objects, dragging and dropping objects or files, etc.

Of course, should the mouse cursor need to interact with aspects outside of region 60a, i.e., in region 60b, the active cursor can be switched or toggled from 50a to 50b, at which time cursor 50b would be circled or otherwise highlighted as discussed above (not shown). Cursor 50a, now inactive, would be un-circled (or un-highlighted). Additionally, the inactive cursor 50a's position might be reset. For example, the position of inactive mouse cursor 50a in a preferred embodiment might be reset to the center of region 60a. Centering of the inactive mouse cursor might be preferred where it is uncertain what the user -would want to interact with next when he returns to region 60a, and so through centering the cursor is made generally equidistant. Of course, other default locations or pre-determined locations could be used for the inactive cursors, such as the upper left corners of the respective regions, etc.

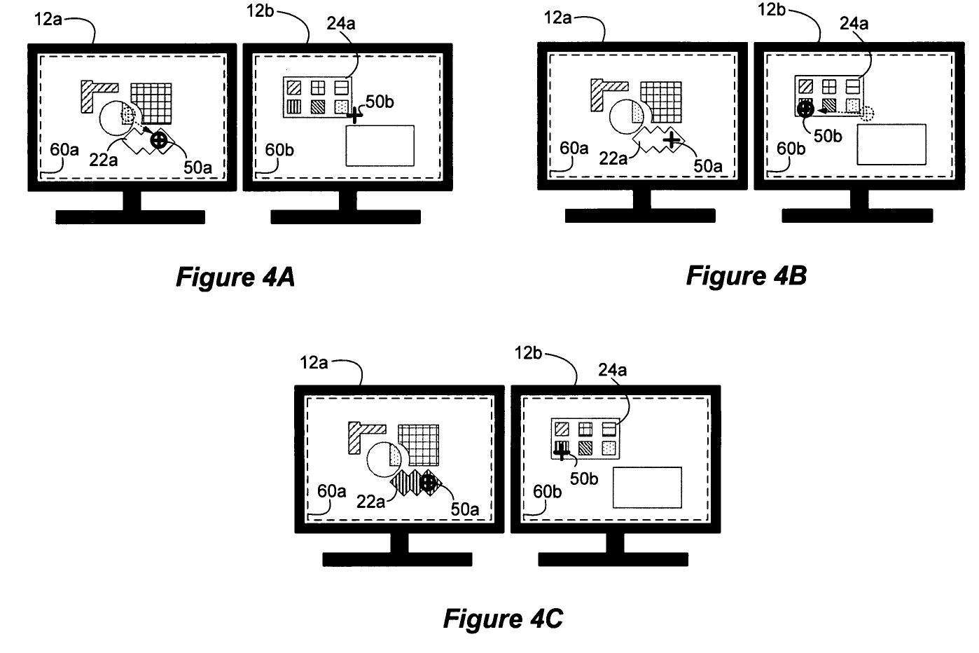

However, in other embodiments, the now-inactivated mouse cursor could be left in the position where it was last active. Such an embodiment might be useful in the shape filling example discussed above, and is illustrated with respect to FIGS. 4A-4C. As shown, starting with FIG. 4A, mouse cursor 50a is initially active and centered, while mouse cursor 50b is initially inactive and centered. The active cursor 50a is then moved using the mouse 16 (not shown) to the shape 22a to be filled. Then, as shown in FIG. 4B, the cursors are switched or toggled so that cursor 50b is made active. When cursor 50a is rendered inactive, it stays at the location where it selected the shape 22a (as opposed to being re-centered in region 60a). Now-active cursor 50b can then be moved from its initially centered position to the select the desired fill of palette 24a. Then, as shown in FIG. 4C, the mouse cursors can again be switched so that cursor 50a is once again active and cursor 50b is once again inactive. Inactive cursor 50b as shown stays in its previous location (over the fill). Now-active cursor 50a, left in its original position over shape 22a, can now be used to apply the fill selected in FIG. 4B by cursor 50b. Thus, because cursor 50a was left in position, the user need not further move that cursor (or the mouse) to apply the fill, saving time. Likewise, should it be desired to use the particular fill again, cursor 50b is appropriately placed, perhaps saving the user time in filling other like shapes.

Switching or toggling among the mouse cursors to render one active can occur in any number of ways. In a preferred embodiment, a key on the keyboard 14 (see FIG. 3) could be used, which is preferred because the user's free hand, i.e., the hand not used for manipulating the mouse 16, can be used to switch. Any key can be used, and in a preferred embodiment the key would be one that the user would otherwise not often use during use of the application program 20, such as the Tab key, the Caps Lock Key, etc. Alternatively, the space bar 14a could be used to switch, or one of the mouse buttons or scrolling wheels (not shown). In a most preferred embodiment, either the application program 20 or the operating system for the computer 10 could allow the user to program which key will be used for the switching function. Should that key normally perform some other function, programming of it would preferably disable that other function, at least temporarily while the application program 20 having the multiple mouse cursors is running.

In another modification, and in an embodiment in which the switching key on the keyboard is one which would otherwise be widely used during the application, the switching function can be achieved by pressing a key, such as the space bar, only when the active mouse cursor is being moved by the mouse 16. In this way, the key used to perform the switching function can be used for its normal purpose when the mouse 16 is not being moved, and can be used to switch between the active and inactive mouse cursors when the mouse 16 is being moved.

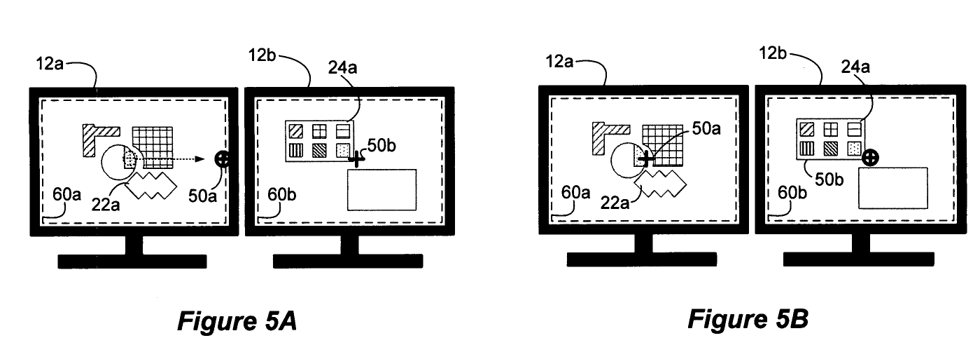

Switching or toggling among active and inactive mouse cursors can occur in other ways. For example, in embodiments in which the mouse cursors are restrained and can appear only in their respective regions (i.e., cursor 50a in region 60a; cursor 50b in region 60b in FIG. 3), movement of the active cursor to the boundary between the regions can cause the activity of the cursors to switch. Thus, as shown in FIG. 5A, the active mouse cursor 50a is moved to the boundary between regions 60a and 60b. When this occurs, the mouse cursor 50b, which originally was centered within its region 60b, is automatically made active, as shown in FIG. 5B. As shown in FIG. 5B, the now-inactive cursor 50a is returned to its central position within its region 60a, although it could be positioned using any of the schemes discussed above (e.g., last active position, other pre-determined location, etc.).

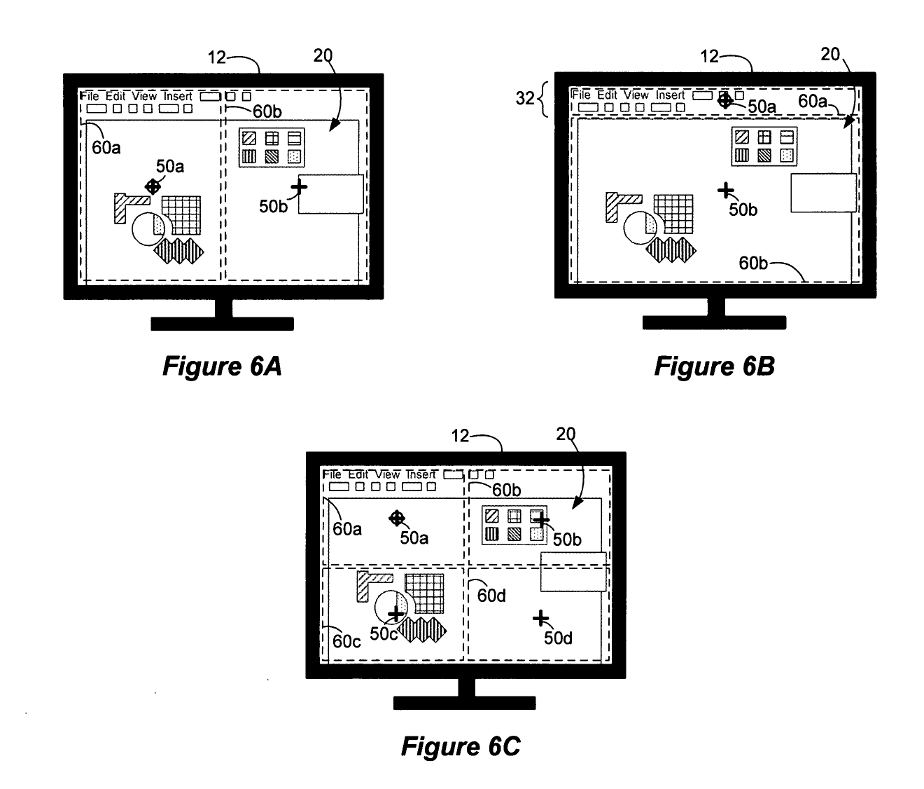

Although the foregoing embodiments illustrate embodiments of the invention in which multiple monitors 12a, 12b are used, it should be noted that the techniques can be used within a single monitor as illustrated in FIGS. 6A-6C, in which multiple arbitrary regions can be set up to restrain the positioning of their respective mouse cursors within a given monitor 12's viewable area. Thus, in FIG. 6A, regions 60a and 60b are defined to encompass left and right portions of the viewable area of the monitor. (Again, while the regions are shown as dotted line boxes for ease of understanding, one skilled in the art will recognize that regions 60a, 60b essentially define a border between the entirety of the left and right portions of the monitor). In FIG. 6B, region 60a is defined to encompass the menu/toolbar area 32 of the application program 20, thus allowing positioning of a mouse cursor in an area where much user activity would normally take place, while region 60b is defined to encompass the general workspace in the application program. In FIG. 6C, four regions 60a-60d are defined as quadrants, each with their own cursors 50a-50d. Such regions can be defined by the application program 20 or the operating system, or can be made user-programmable. For example, a user might find it convenient to set up a region around a particular palette 24.

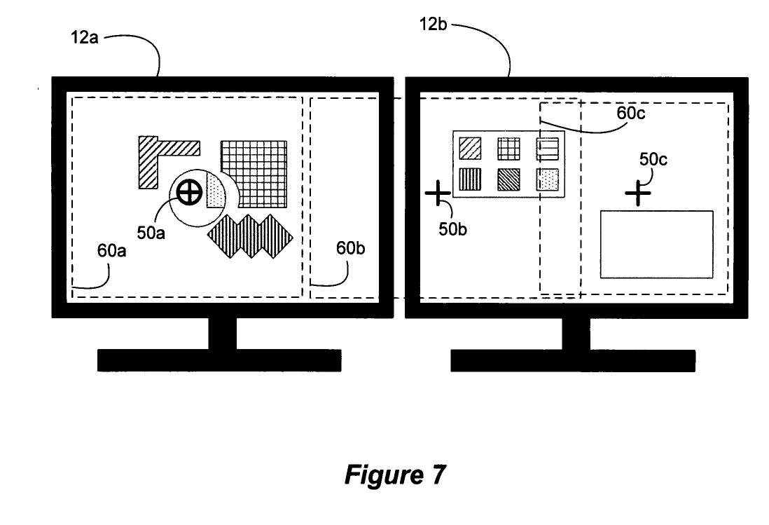

It should be understood that means for switching or toggling among the active and inactive mouse cursors in the one-monitor-embodiments of FIG. 6 can be achieved using any of the means earlier disclosed. In this regard, there is little if any difference between the disclosed techniques when applied to multiple mouse cursor usage on a single monitor or on multiple monitors. Indeed, the regions encompassing the cursors can be made to extend beyond the physical borders of particular monitors, such as with region 60b of FIG. 7.

As the embodiments of FIG. 6C and 7 should make clear, the disclosed techniques are not limited to the use of two mouse cursors, but are easily extended to the use of any number of cursors. When using more than two mouse cursors, switching or toggling among the cursors would preferably occur cyclically (e.g., in FIG. 7, from cursor 50a, to 50b, to 50c, then back to 50a) using any of the same switching mechanism noted earlier, most preferably through the use of a dedicated toggling key on the keyboard. However, activating a particular mouse cursor can also occur by user selection. For example, if the monitors are touch screen monitors, touching an appropriate region can be used to activate the mouse cursor in that region. Or, multiple toggling keys or mouse buttons can be used to activate the mouse cursor of interest (e.g., Tab for cursor 50a, Caps Lock for cursor 50b, Shift for cursor 50c).

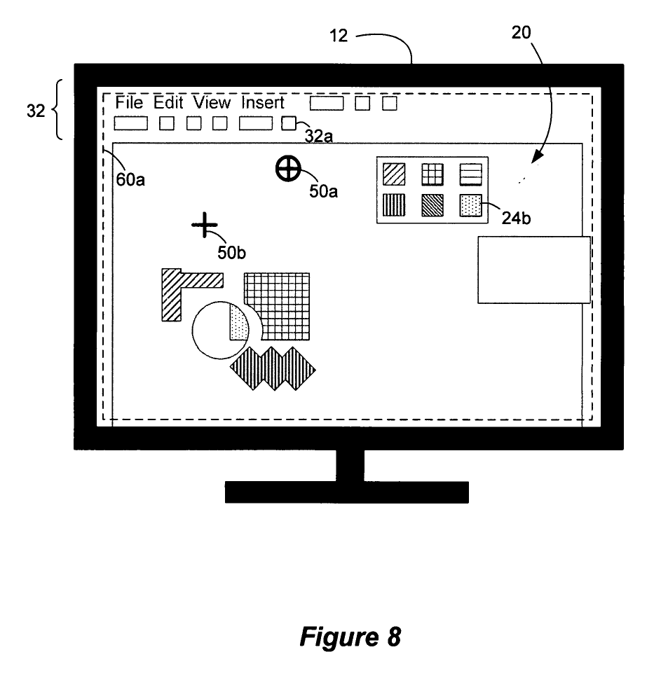

While the foregoing embodiments illustrate multiple mouse cursor techniques in which the cursors are restrained to their respective regions, not all useful embodiments need be so implemented. For example, and as shown in FIG. 8, two mouse cursors, one active 50a and one inactive 50b, can be allowed to move within the same region 60a (here shown as the viewable space within a single monitor). As before, only the active mouse cursor 50a moves within the region 60a, while the other inactive mouse cursor 50b within the region will not move. The ability to freely position the active and inactive mouse cursors within the region can be advantageous. To illustrate an example, one mouse cursor can be positioned over a selection that the user has frequent need to engage, such as a particular button 32a or menu item or a particular fill 24b on the palette. In this way, the user can move with the active cursor 50a from shape to shape and can toggle the active cursor to easily select the desired button or fill without the need to move the mouse to select such features. Of course, this is just one example. One will recognize the other advantages to have the ability to place and manipulate two or more mouse cursors within a given viewable area. Moreover, because two mouse cursors can occupy the same region within the viewable area, it should be obvious that the regions (e.g., 60a, 60b) may also be made to overlap, such that the cursors are constrained to their regions, but can also move into a common area between them (not shown). An illustration of overlapping regions is shown in FIG. 7 (regions 60b and 60c).

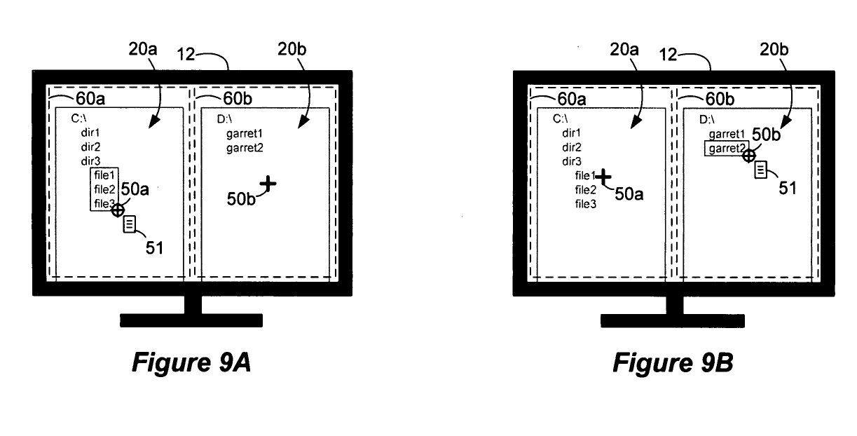

As alluded to earlier, a given mouse cursor can be associated with data to be applied elsewhere within the viewable area. As an illustration of this, and referring back to the example of FIG. 4, note that the cursor 50b is associated with data pertaining to a fill in FIG. 4B, which data is then later associated with the cursor 50a in FIG. 4C to apply the fill. In another example, as illustrated in FIG. 9, the regions 60a, 60b bind two file management programs 20a, 20b. In FIG. 9A, the user has selected certain files (files1-3) to be copied, moved, or pasted from program 20a to 20b. Accordingly, the active cursor 50a in FIG. 9A is shown as associated with the data for these files (illustrated by this example as a graphic 51, which tracks the cursor). Later, in FIG. 9B, the user has activated the cursor 50b using the switching techniques earlier discussed, and the associated data is move accordingly to allow the files to be “dropped” or “dragged” to a different directory (D:\garret2). In either example, it should be understood that the active mouse cursor's association with the data (whether or not illustrated by a graphic 51) will be moved and re-associated with the new active cursor when it is toggled, regardless of whether such data is indicated by a graphic 51 or not. Such re-association is easily established from within the coding from the applications programs, or the operating system, or both, as one skilled in the art will understand.

In less preferred embodiments of the invention, the inactive cursors (e.g., 50b) can simply not be displayed at all, which might in some cases alleviate user confusion as to the cursor which is presently active and moveable using the mouse. In short, instead of displaying inactive cursors in a non-highlighted fashion, such cursors can simply not be displayed at all until such time as they are selected (i.e., switched to) by the users, at which point of course they would be displayed on the viewable area of the computer (perhaps as confined to its respective region).

Additionally, should a user provided with multiple mouse cursors not wish to use such improved functionality, it could be rendered temporarily or permanently disabled to return the user to a more traditional single-mouse-cursor approach. For example, the user may wish in a given mouse cursor manipulation step to temporarily allow the active mouse cursor to transgress outside of its region (i.e., in those embodiments in which a given cursor is constrained to a particular region). In such an instance, the user can temporarily disable the border constraints provided by the cursor's region to allow the cursor to move outside of the region, for example, by pressing (and perhaps pressing and holding) a particular key on the keyboard or a particular mouse button. Either temporary or permanents disablement of the multiple cursor option could be achieved via an appropriate selection in a preferences window, as one skilled in the art would recognize.

With the foregoing illustrating basic descriptions of the multiple mouse cursor technique in its various forms, details of an exemplary implementation are discussed by way of an experiment used to test the utility of the technique. While this experiment was coded in a particular environment deemed suitable for testing, one skilled in the art will recognize that in an actual implementation of the technique that coding similar to that described below (with necessary routine modifications for the coding environment in question) would be made, and that such coding could occur as the application program level (to allow particular programs to run multiple cursors) or at the operating system level (to allow all programs running within the operating system to use multiple cursors). Implementation of the technique at the operating system level is believed particular significant, as current operating systems (such as Microsoft Windows™, Apple OS X™, etc.) are understood to support one mouse cursor. Either way, implementation at either the operating system level or at the level of a specific application program would be a routine undertaking given the basic description of the technique discussed below. Moreover, the technique can be coded into an operating system or application program in the first instance, or can constitute an augmentation to such environments. Depending on the environment and manner in which it is coded, the technique can be used in any display environment, such as across application programs in an operating system, within particular application programs, from between suites or families of programs, or more generically within a given window or between given windows or regions in the viewable area of a computer.

In the experiment, Macromedia Flash™ (“Flash”) was used in conjunction with MDM Flash Studio Pro™ (“Flash Studio Pro”) to illustrate the utility of the disclosed technique. As one skilled in the art will understand, Flash Studio Pro is an extension used to increase Flash's utility and functionality. As relevant here, Flash Studio Pro provides routines which allow the X-Y position of a mouse cursor to be retrieved (“get cursor”) and set (“set cursor”).

In the experiment using Flash, Flash removed the mouse cursor image provided by the operating system from the viewable area. In its place, multiple mouse cursor images were generated and displayed in the viewable area, with their positions noted and stored (“active_cursor_x_position,” “active_cursor_y_position, ” “inactive_cursor_x_position,” (“inactive_cursor_y_position”; this of course assumes only two cursors are used).

Using Flash, the movement of the operating system mouse was tracked, even though the cursor image had been removed, with the active cursor image being displayed where the operating system's cursor would be. This allowed the active cursor image to move in accordance with the operating system cursor. The inactive mouse cursor's image (50b), by contrast, remained a mere graphic whose location had been stored previously noted.

Key presses were tracked using Flash, including any keys (e.g., the space bar) designed to toggle the active mouse as noted earlier. When the activation of such a toggling key was detected, or any other event designed to toggle between cursors such as those mentioned above, a “switch cursor” function was invoked, which included and used the “get cursor” and “set cursor” functions noted earlier. Specifically, the “switch cursor” function first retrieved and stored the present location of the active cursor (50a) (using “get cursor”), and the previously-stored X-Y position for the inactive cursor (50b) was retrieved and set (using “set cursor.”). Finally, the images for the active and inactive cursors were switched. (If necessary, the newly inactivated cursor's image (50a) can be reset to the center of its corresponding region, as discussed above, in embodiments in which a cursor's previous position is not maintained). As will be understood, this mapping and tracking of the various X-Y coordinates may require understanding and application of various offsets to account for differences in the origin values for the mouse cursor as understood by the operating system, but correcting for such coordinate shifts is a routine matter.

Moreover, because the experiment employed the embodiment in which a particular mouse cursor image was bound to a particular region, Flash tracked the position of the active cursor (e.g., using “get cursor”). If the cursor was detected to be outside of the cursor's associated region, the cursor was set back to a position within the region (using “set cursor”) to in effect limit the cursor's movement to within the particular region.

Further details concerning use of the disclosed techniques, and experimental results, are included in a paper submitted by the inventor for publication: Wilson Chan & Sheryl Ehrlich, “Cursor Jumping: Using Multiple Cursors to Minimize Cursor Movement Across a Multi-Monitor Display,” submitted to CHI 2005 on Dec. 13, 2004. The submitted paper is included with an Information Disclosure Statement being filed with this patent application, and is incorporated by reference in its entirety.

The present disclosure amply illustrates to a computer programmer of skill how to implement the disclosed techniques, the accompanying user interfaces, and other functional aspects of the present disclosure. Therefore, programming such algorithms, accompanying user interfaces, and other functional aspects is a routine matter to a computer programmer of skill and can be accomplished using many different programming languages and within the context of many different operating systems. Of course, the disclosed algorithms, the accompanying user interfaces, and other functional aspects would be ultimately coded into a computer code and stored on a computer-readable media, such as a compact disc, a tape, stored in a volatile or non-volatile memory, etc.

While disclosed in the context of a traditional computer, it should be understood that the disclosed methods are not so limited. For example, the disclosed methods can have applicability with respect to other devices such as handheld devices (Personal Data Assistants, cell phones, etc.) and other multimedia devices (such as televisions, etc.), or other electronic display devices, all of which should be considered as “computers” for purposes of this disclosure.

As used herein, the “viewable area” of a computer should be understood as denoting that area or those areas which a particular computer is capable of controlling, whether it be a single, dual, or multiple monitors, single, dual, or multiple windows, or other structures other than monitors, such as a projection screen. In this regard, it is worth noting that the disclosed multiple-mouse-cursor techniques are expected to have particular utility in multimedia applications having different types of viewing mediums. For example, a notebook computer coupled to a projector display could comprise two different regions (such as 60a, 60b) each with its own cursors (such as 50a, 50b), which together comprise a single “viewable area.” A “viewable area” may also be understood to include discrete aspects within the viewable area of the monitor, such as individual windows displayed as part of the graphical user interface. Furthermore, while disclosed as being a traditional two-dimensional space, a “viewable area” can encompass newer technologies having a three-dimensional flavor, such as heads up displays, projective displays such as holograms for example, etc.

A “mouse” as used herein should be understood as including any device capable of translating a user's multi-directional movements into a multi-dimensional movement of the mouse cursor within the moveable area, and so would include traditional mobile mice, pointing devices, trackballs, and touchpads activatable by a user's fingertip (such as trackpoints used in conventional laptop computers), whether 2-dimensional or 3-dimensional in nature. “Moving” of the cursor should be understood as smooth, pixel-by-pixel movement.

The foregoing description of preferred and other embodiments is not intended to limit or restrict the scope or applicability of the inventive concepts disclosed. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A method for manipulating a plurality of cursors in the viewable area of a computer, comprising: displaying a plurality of cursors within the viewable area, only a first of which is active and capable of movement throughout the entirety of at least a portion of the viewable area using an input device, wherein the other cursors can be selected by the user and can be made moveable using the input device starting from their displayed positions, but are presently inactive and incapable of movement using the input device.

2. The method of claim 1, further comprising subsequently selecting a second cursor different from the first cursor, thereby rendering the second cursor active and capable of movement starting from its displayed position throughout the entirety of at least a portion of the viewable area using the input device, wherein the other cursors aside from the second cursor are presently inactive and incapable of movement.

3. The method of claim 2, wherein selecting the second cursor causes the positions of the inactive cursors to be stored as their last-active positions.

4. The method of claim 2, wherein selecting the second cursor causes the position of the inactive cursors to be set and stored to pre-determined positions.

5. The method of claim 2, wherein each of the plurality of cursors is bound to its own region within the viewable area.

6. The method of claim 5, wherein selecting the second cursor comprises moving the first cursor to a boundary of its region.

7. The method of claim 2, wherein selecting the second cursor comprises selecting a key coupled to the computer.

8. The method of claim 2, wherein the first cursor, when active, is associated with data, and further comprising re-associating the data with the second cursor when it is selected.

9. A method for manipulating a plurality of cursors in the viewable area of a computer, comprising:
displaying a plurality of cursors within the viewable area; and
toggling among the cursors to activate only one of the cursors, wherein only the active cursor is allowed to move starting from its displayed position via control of an input device while the other cursors are render inactive and remain stationary.

10. The method of claim 9, wherein activating a cursor causes the positions of the inactive cursors to be stored as their last-active positions.

11. The method of claim 9, wherein activating a cursor causes the position of the inactive cursors to be set and stored to pre-determined positions.

12. The method of claim 9, wherein each of the plurality of cursors is bound to its own region within the viewable area.

13. The method of claim 12, wherein the regions are non-overlapping.

14. The method of claim 9, wherein toggling among the cursors comprises selecting a key coupled to the computer.

15. The method of claim 9, wherein activating a cursor comprises re-associating data associated with a previously-active cursor.

16. The method of claim 9, wherein the active cursor is visually different from the other cursors.

17. A method for manipulating a plurality of mouse cursors in the viewable area of a computer, comprising:
displaying a plurality of mouse cursors, wherein each of the plurality of cursors is displayed in a region of the viewable area associated with each cursor;
activating a first of the plurality of cursors to allow the first cursor to move within its region via control by a mouse coupled to the computer, wherein the other cursors remain stationary within their regions; and thereafter
activating a second of the plurality of cursors to allow the second cursor to move within its region starting from its displayed position via control by the mouse, wherein the other cursors remain stationary within their regions.

18. The method of claim 17, wherein activating the second cursor comprises selecting a key coupled to the computer.

19. The method of claim 17, wherein activating the second cursor comprises re-associating data associated with the first cursor with the second cursor.

20. A viewable area for a computer, comprising:
a first active cursor controllable in its movement by an input device coupled to the computer; and
at least one second inactive cursor, wherein the second inactive cursor or any one of the second inactive cursors is selectable to render it controllable in its movement from its present position by the input device.

21. The viewable area of claim 20, wherein the input device comprises a mouse.

22. The viewable area of claim 20, wherein each of the plurality of cursors is bound to a region within the viewable area.

23. The viewable area of claim 20, wherein the one of the at least one second inactive cursor is selectable by using a key coupled to the computer.

24. A computer-readable medium containing a program for performing a method for manipulating a plurality of cursors in the viewable area of a computer, the method comprising: displaying a plurality of cursors within the viewable area, only a first of which is active and capable of movement throughout the entirety of at least a portion of the viewable area using an input device, wherein the other cursors can be selected by the user and can be made moveable using the input device starting from their displayed positions, but are presently inactive and incapable of movement using the input device.

25. A computer-readable medium containing a program for performing a method for manipulating a plurality of cursors in the viewable area of a computer, the method comprising:
displaying a plurality of cursors within the viewable area; and
toggling among the cursors to activate only one of the cursors, wherein only the active cursor is allowed to move starting from its displayed position via control of an input device while the other cursors are render inactive and remain stationary.
